(19) United States
(12) Patent Application Publication
(10) Pub. No.: US 2012/0201226 A1
(43) Pub. Date: Aug. 9, 2012

(54) SWITCHING-BASED DOWNLINK AGGREGATION FOR MULTI-POINT HSDPA

(76) Inventors: Sharad Deepak Sambhwani, San Diego, CA (US); Pavan Kumar Vitthaladevuni, San Diego, CA (US); Danlu Zhang, San Diego, CA (US); Jilei Hou, San Diego, CA (US)

(21) Appl. No.: 13/187,717

(22) Filed: Jul. 21, 2011

Related U.S. Application Data
(60) Provisional application No. 61/374,192, filed on Aug. 16, 2010.

(51) Int. Cl. H04W 36/30; H04W 36/24

(52) U.S. Cl. 370/332; 370/331

(57) ABSTRACT

A Multi-Point HSDPA system may provide downlink aggregation from multiple cells for a single receive antenna UE without requiring an advanced Type 3i receiver, by providing switching-based scheduling from one of the cells based on channel conditions of the respective cells, as reported by the UE. For example, the UE may monitor the HS-SCCH from both cells so that it may decode the HS-DSCH in any particular TTI as data is scheduled. The UE may further transmit a CQI for each of the cells, so that scheduling decisions between the cells at each TTI may be dynamically made to provide the downlink packet from the better of the cells.

### CROSS-REFERENCE TO RELATED APPLICATIONS

This application claims priority to and the benefit of provisional patent application No. 61/374,192, filed in the United States Patent and Trademark Office on Aug. 16, 2010, the entire content of which is incorporated herein by reference.

### BACKGROUND

1. Field

Aspects of the present disclosure relate generally to wireless communication systems, and more particularly, to downlink carrier aggregation in wireless communication systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

For example, many mobile stations include advanced receivers with interference suppression so that they are better able to maintain a call at or near the edge of a cell. In addition, many mobile stations include multiple receive antennas, also called receiver diversity, to mitigate the effects of fading. However, due to the relative expense and complexity of these solutions, there remains interest in the improvement of mobile stations utilizing a single receive antenna other than implementing advanced Type 3i receivers.

### SUMMARY

Aspects of the present disclosure may improve coverage for single receive antenna UEs despite moving into a location of a deep fade or being at or near an edge of a cell. Some aspects of the present disclosure may be considered similar to dynamically switching the serving cell for a UE over certain time intervals, based on the channel quality of the corresponding cells. That is, if the downlink from one cell exhibits poor channel quality during a certain time interval, then data may be scheduled and transmitted from a different cell in the next interval.

Specifically, the UE may monitor a control channel (e.g., a HS-SCCH) coming on a downlink from each of a plurality of cells: the serving cell, which is currently serving the UE, and at least one non-serving cell. In a Multi-Point HSDPA system, the HS-SCCH from each of the cells may be transmitted using the same frequency. The UE may additionally report on an uplink transmission the channel quality of the received control channels, using a channel quality indicator (CQI).

The network may then schedule data to be transmitted to the UE during a particular transmission time interval (TTI) from only one of the cells: the one corresponding to the better link, based at least in part on the CQIs.

In one aspect, the disclosure provides a method of wireless communication including monitoring a first control channel from a first cell and a second control channel from a second cell, wherein the first cell and the second cell provide respective downlink data channels in the same carrier frequency. The method may further include decoding downlink data on only one of the first downlink data channel or the second downlink data channel during a first time interval.

Another aspect of the disclosure provides method of wireless communication including transmitting a first pilot signal for a first cell, transmitting a second pilot signal for a second cell, receiving from a UE at least one channel quality indicator corresponding to a characteristic of the first pilot signal and second pilot signal, determining, based at least in part on the at least one channel quality indicator, a better cell among the first cell and the second cell, and scheduling a packet for the UE on the better cell.

Yet another aspect of the disclosure provides an apparatus for wireless communication including a receiver for receiving a first reference signal from a first cell and a second reference signal from a second cell, wherein the first cell and the second cell are in the same carrier frequency, a channel processor for determining a first channel estimate corresponding to the first reference signal and a second channel estimate corresponding to the second reference signal, a transmitter for transmitting a first channel quality indication corresponding to the first channel estimate and a second channel quality indication corresponding to the second channel estimate, a receive processor for receiving first control information from the first cell and second control information from the second cell, and for providing decoding control information for decoding a data channel; and a controller for decoding only one of a first data channel or a second data channel in accordance with the decoding control information for a corresponding one of the first cell or the second cell during a first time interval.

Still another aspect of the disclosure provides an apparatus for wireless communication including means for monitoring a first control channel from a first cell and a second control channel from a second cell, wherein the first cell provides a first downlink data channel in a first carrier frequency and the second cell provides a second downlink data channel in the first carrier frequency, and means for decoding downlink data on only one of the first downlink data channel or the second downlink data channel during a first time interval.

Still another aspect of the disclosure provides an apparatus for wireless communication including means for transmitting a first pilot signal for a first cell, means for transmitting a second pilot signal for a second cell, means for receiving from a UE at least one channel quality indicator corresponding to a characteristic of the first pilot signal and second pilot signal, means for determining, based at least in part on the at least one channel quality indicator, a better cell among the first cell and the second cell, and means for scheduling a packet for the UE on the better cell.

Still another aspect of the disclosure provides a computer program product including a computer-readable medium having code for monitoring a first control channel from a first cell and a second control channel from a second cell, wherein the first cell provides a first downlink data channel in a first carrier frequency and the second cell provides a second downlink data channel in the first carrier frequency, and code for decoding downlink data on only one of the first downlink data channel or the second downlink data channel during a first time interval.

Still another aspect of the disclosure provides a computer program product including a computer-readable medium having code for transmitting a first pilot signal for a first cell, code for transmitting a second pilot signal for a second cell, code for receiving from a UE at least one channel quality indicator corresponding to a characteristic of the first pilot signal and second pilot signal, code for determining, based at least in part on the at least one channel quality indicator, a better cell among the first cell and the second cell, and code for scheduling a packet for the UE on the better cell.

Still another aspect of the disclosure provides an apparatus for wireless communication including at least one processor and a memory coupled to the at least one processor, wherein the at least one processor is configured to monitor a first control channel from a first cell and a second control channel from a second cell, wherein the first cell provides a first downlink data channel in a first carrier frequency and the second cell provides a second downlink data channel in the first carrier frequency, and decode downlink data on only one of the first downlink data channel or the second downlink data channel during a first time interval.

Still another aspect of the disclosure provides an apparatus for wireless communication including at least one processor and a memory coupled to the at least one processor, wherein the at least one processor is configured to transmit a first pilot signal for a first cell, transmit a second pilot signal for a second cell, receive from a UE at least one channel quality indicator corresponding to a characteristic of the first pilot signal and second pilot signal, determine, based at least in part on the at least one channel quality indicator, a better cell among the first cell and the second cell, and schedule a packet for the UE on the better cell.

These and other aspects of the invention will become more fully understood upon a review of the detailed description, which follows.

### BRIEF DESCRIPTION OF THE DRAWINGS

FIG. 1 is a block diagram illustrating an example of a hardware implementation for an apparatus employing a processing system.

FIG. 2 is a conceptual diagram illustrating an example of a radio protocol architecture for the user and control plane.

FIG. 3 is a block diagram conceptually illustrating an example of a telecommunications system.

FIG. 4 is a conceptual diagram illustrating an example of an access network.

FIG. 5 is a diagram illustrating timing for a control channel and a data channel in an HSDPA system.

FIG. 6 is a conceptual diagram illustrating switching based aggregation in a single-carrier system.

FIG. 7 is a conceptual diagram illustrating switching based aggregation from a single base station in a single-carrier system.

FIG. 8 is a conceptual diagram illustrating switching based aggregation in a dual carrier system.

FIG. 9 is a conceptual diagram illustrating switching based aggregation from a single base station in a dual-carrier system.

FIG. 10 is a block diagram conceptually illustrating an example of a Node B in communication with a UE in a telecommunications system.

FIG. 11 is a block diagram schematically illustrating portions of an RF front end of a receiver in a UE.

FIG. 12 is a block diagram schematically illustrating portions of a baseband processor in a UE.

FIG. 13 is a flow chart illustrating a process for wireless communication that may be performed by a UE.

FIG. 14 is a flow chart illustrating a process for wireless communication that may be performed by a Node B.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

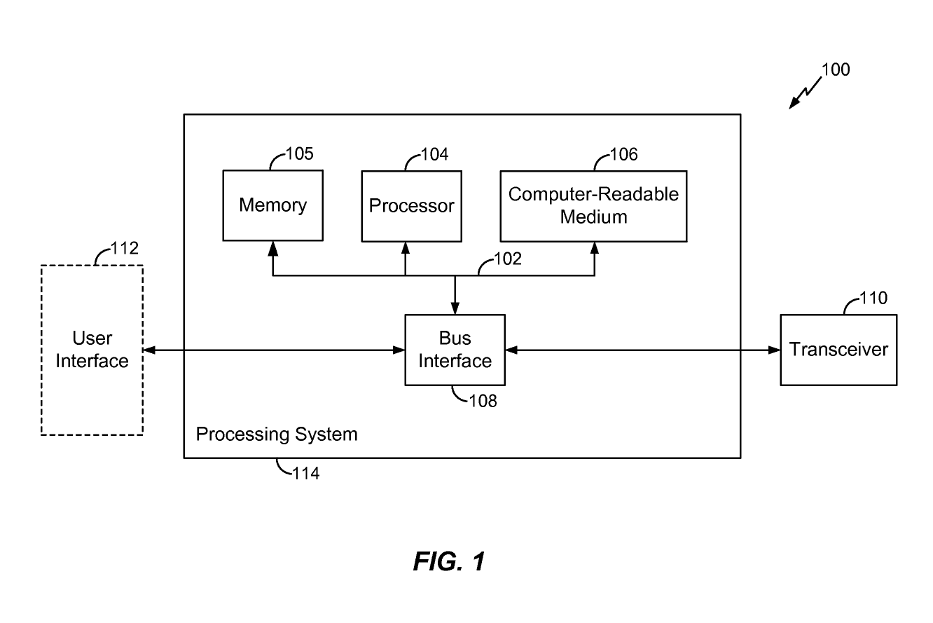

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, a memory 105, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

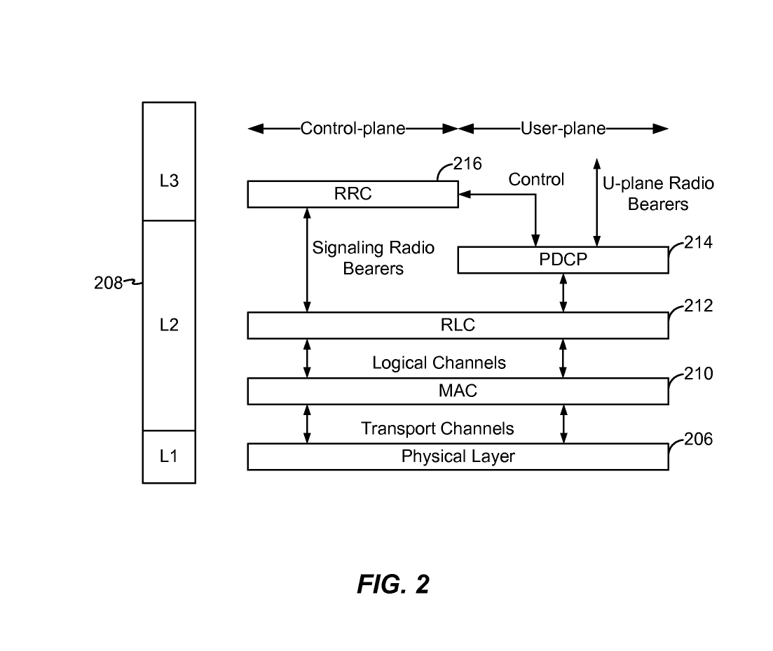

In a wireless telecommunication system, the radio protocol architecture between a mobile device and a cellular network may take on various forms depending on the particular application. An example for a 3GPP high-speed packet access (HSPA) system will now be presented with reference to FIG. 2, illustrating an example of the radio protocol architecture for the user and control planes between user equipment (UE) and a base station, commonly referred to as a Node B. Here, the user plane or data plane carries user traffic, while the control plane carries control information, i.e., signaling.

Turning to FIG. 2, the radio protocol architecture for the UE and Node B is shown with three layers: Layer 1, Layer 2, and Layer 3. Layer 1 is the lowest layer and implements various physical layer signal processing functions. Layer 1 will be referred to herein as the physical layer 206. The data link layer, called Layer 2 (L2 layer) 208 is above the physical layer 206 and is responsible for the link between the UE and Node B over the physical layer 206.

At Layer 3, the RRC layer 216 handles the control plane signaling between the UE and the Node B. RRC layer 216 includes a number of functional entities for routing higher layer messages, handling broadcast and paging functions, establishing and configuring radio bearers, etc.

In the illustrated air interface, the L2 layer 208 is split into sublayers. In the control plane, the L2 layer 208 includes two sublayers: a medium access control (MAC) sublayer 210 and a radio link control (RLC) sublayer 212. In the user plane, the L2 layer 208 additionally includes a packet data convergence protocol (PDCP) sublayer 214. Although not shown, the UE may have several upper layers above the L2 layer 208 including a network layer (e.g., IP layer) that is terminated at a PDN gateway on the network side, and an application layer that is terminated at the other end of the connection (e.g., far end UE, server, etc.).

The PDCP sublayer 214 provides multiplexing between different radio bearers and logical channels. The PDCP sublayer 214 also provides header compression for upper layer data packets to reduce radio transmission overhead, security by ciphering the data packets, and handover support for UEs between Node Bs.

The RLC sublayer 212 provides segmentation and reassembly of upper layer data packets, retransmission of lost data packets, and reordering of data packets to compensate for out-of-order reception due to a hybrid automatic repeat request (HARQ).

The MAC sublayer 210 provides multiplexing between logical and transport channels. The MAC sublayer 210 is also responsible for allocating the various radio resources (e.g., resource blocks) in one cell among the UEs. The MAC sublayer 210 is also responsible for HARQ operations.

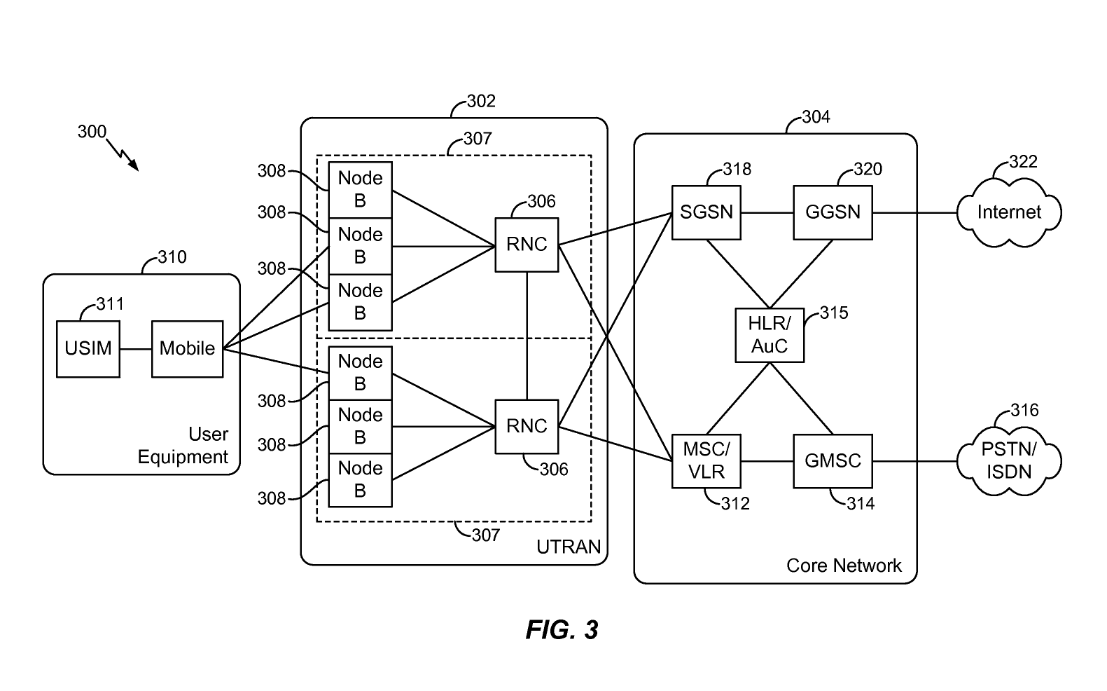

The various concepts presented throughout this disclosure may be implemented across a broad variety of telecommunication systems, network architectures, and communication standards. Referring now to FIG. 3, by way of example and without limitation, various aspects of the present disclosure are illustrated with reference to a Universal Mobile Telecommunications System (UMTS) system 300 employing a W-CDMA air interface. A UMTS network includes three interacting domains: a Core Network (CN) 304, a UMTS Terrestrial Radio Access Network (UTRAN) 302, and User Equipment (UE) 310. In this example, the UTRAN 302 may provide various wireless services including telephony, video, data, messaging, broadcasts, and/or other services. The UTRAN 302 may include a plurality of Radio Network Subsystems (RNSs) such as an RNS 307, each controlled by a respective Radio Network Controller (RNC) such as an RNC 306. Here, the UTRAN 302 may include any number of RNCs 306 and RNSs 307 in addition to the illustrated RNCs 306 and RNSs 307. The RNC 306 is an apparatus responsible for, among other things, assigning, reconfiguring and releasing radio resources within the RNS 307. The RNC 306 may be interconnected to other RNCs (not shown) in the UTRAN 302 through various types of interfaces such as a direct physical connection, a virtual network, or the like, using any suitable transport network.

Communication between a UE 310 and a Node B 308 may be considered as including a physical (PHY) layer and a medium access control (MAC) layer. Further, communication between a UE 310 and an RNC 306 by way of a respective Node B 308 may be considered as including a radio resource control (RRC) layer.

The geographic region covered by the RNS 307 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 308 are shown in each RNS 307; however, the RNSs 307 may include any number of wireless Node Bs. The Node Bs 308 provide wireless access points to a core network (CN) 304 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 310 may further include a universal subscriber identity module (USIM) 311, which contains a user's subscription information to a network. For illustrative purposes, one UE 310 is shown in communication with a number of the Node Bs 308. The downlink (DL), also called the forward link, refers to the communication link from a Node B 308 to a UE 310, and the uplink (UL), also called the reverse link, refers to the communication link from a UE 310 to a Node B 308.

The core network 304 interfaces with one or more access networks, such as the UTRAN 302. As shown, the core network 304 is a GSM core network. However, as those skilled in the art will recognize, the various concepts presented throughout this disclosure may be implemented in a RAN, or other suitable access network, to provide UEs with access to types of core networks other than GSM networks.

The illustrated GSM core network 304 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains.

In the illustrated example, the core network 304 supports circuit-switched services with a MSC 312 and a GMSC 314. In some applications, the GMSC 314 may be referred to as a media gateway (MGW). One or more RNCs, such as the RNC 306, may be connected to the MSC 312. The MSC 312 is an apparatus that controls call setup, call routing, and UE mobility functions. The MSC 312 also includes a visitor location register (VLR) that contains subscriber-related information for the duration that a UE is in the coverage area of the MSC 312. The GMSC 314 provides a gateway through the MSC 312 for the UE to access a circuit-switched network 316. The GMSC 314 includes a home location register (HLR) 315 containing subscriber data, such as the data reflecting the details of the services to which a particular user has subscribed. The HLR is also associated with an authentication center (AuC) that contains subscriber-specific authentication data. When a call is received for a particular UE, the GMSC 314 queries the HLR 315 to determine the UE's location and forwards the call to the particular MSC serving that location.

The illustrated core network 304 also supports packet-data services with a serving GPRS support node (SGSN) 318 and a gateway GPRS support node (GGSN) 320. GPRS, which stands for General Packet Radio Service, is designed to provide packet-data services at speeds higher than those available with standard circuit-switched data services. The GGSN 320 provides a connection for the UTRAN 302 to a packet-based network 322. The packet-based network 322 may be the Internet, a private data network, or some other suitable packet-based network. The primary function of the GGSN 320 is to provide the UEs 310 with packet-based network connectivity. Data packets may be transferred between the GGSN 320 and the UEs 310 through the SGSN 318, which performs primarily the same functions in the packet-based domain as the MSC 312 performs in the circuit-switched domain.

The UMTS air interface may be a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such DS-CDMA technology and additionally calls for a frequency division duplexing (FDD). FDD uses a different carrier frequency for the uplink (UL) and downlink (DL) between a Node B 308 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface.

A high speed packet access (HSPA) air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

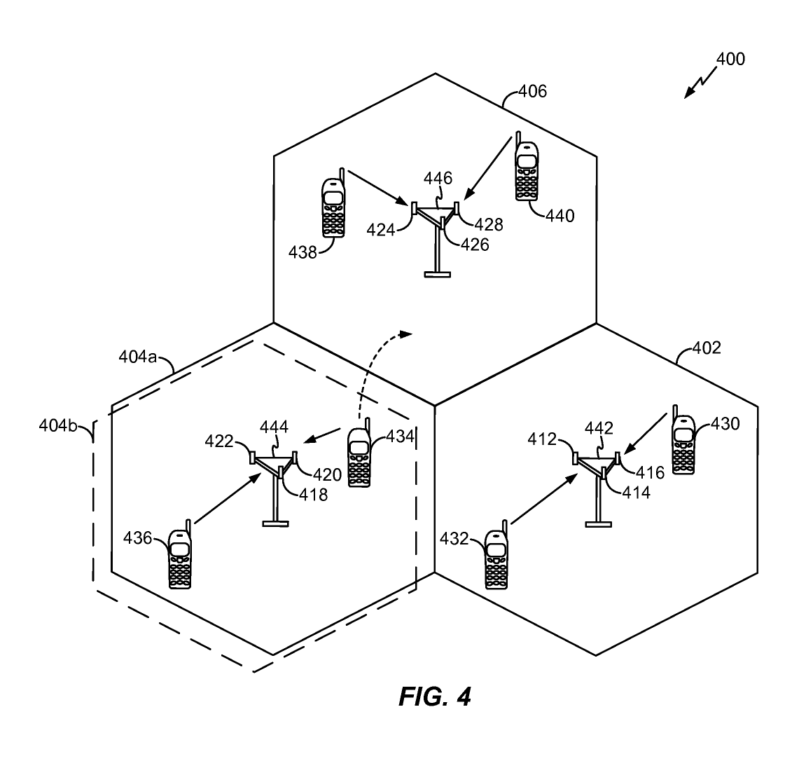

Referring now to FIG. 4, by way of example and without limitation, a simplified access network 400 in a UTRAN architecture, which may utilize HSPA, is illustrated. The system includes multiple cellular regions (cells), including cells 402, 404, and 406, each of which may include one or more sectors. Cells may be defined geographically, e.g., by coverage area, and/or may be defined in accordance with a frequency, scrambling code, etc. That is, the illustrated geographically-defined cells 402, 404, and 406 may each be further divided into a plurality of cells, e.g., by utilizing different scrambling codes. For example, cell 404a may utilize a first scrambling code, and cell 404b, while in the same geographic region and served by the same Node B 444, may be distinguished by utilizing a second scrambling code.

In a cell that is divided into sectors, the multiple sectors within a cell can be formed by groups of antennas with each antenna responsible for communication with UEs in a portion of the cell. For example, in cell 402, antenna groups 412, 414, and 416 may each correspond to a different sector. In cell 404, antenna groups 418, 420, and 422 each correspond to a different sector. In cell 406, antenna groups 424, 426, and 428 each correspond to a different sector.

The cells 402, 404 and 406 may include several UEs that may be in communication with one or more sectors of each cell 402, 404 or 406. For example, UEs 430 and 432 may be in communication with Node B 442, UEs 434 and 436 may be in communication with Node B 444, and UEs 438 and 440 may be in communication with Node B 446. Here, each Node B 442, 444, 446 is configured to provide an access point to a core network 204 (see FIG. 2) for all the UEs 430, 432, 434, 436, 438, 440 in the respective cells 402, 404, and 406.

For simplicity, hereinbelow in the instant disclosure the term “cell” may include cells from different Node Bs and different sectors from the same Node B.

As a UE (e.g., UE 434) moves about the access network 400, the UE 434 may perform various measurements of signal characteristics of the various cells and send reports on uplink transmissions relating to the quality of those signals. Based in part on these reports, the UTRAN may decide to change the UE's serving cell in a handover procedure by transmitting suitable signaling messages instructing the UE 434 to change its serving cell. Here, a serving cell is that cell on which the UE is camped. Handovers may be hard handovers (e.g., break-before-make) or soft handovers (make-before-break). In a soft handover, the UE may for a certain time be simultaneously connected to two or more cells, i.e., a primary serving cell and one or more secondary serving cells. That is, the UE may maintain an Active Set including multiple cells from one or more Node Bs. As the UE moves or the radio conditions otherwise change, cells may be added to and removed from the Active Set.

In Release 5 of the 3GPP family of standards, High Speed Downlink Packet Access (HSDPA) was introduced. As with previous systems, an HSDPA UE generally monitors and performs measurements of certain parameters of the downlink channel. In HSDPA, however, based on these measurements the UE can provide feedback to the Node B on an uplink transmission.

This feedback can include a Channel Quality Indication (CQI), which generally indicates which estimated transport block size, modulation type, and number of parallel codes could be received correctly with reasonable block error rate (BLER) in the downlink. Here, the CQI reports can be utilized for link adaptation and scheduling algorithms. Thus, the Node B may provide subsequent MAC-hs/MAC-ehs packets to the UE on downlink transmissions having a size, coding format, etc., based on the reported CQI from the UE. In addition, the CQI reports may be utilized for capacity estimation for an air interface.

HSDPA utilizes as its transport channel the high-speed downlink shared channel (HS-DSCH), which may carry user data in the downlink direction. An HS-DSCH Transmission Time Interval (TTI) or interleaving period may be 2 ms (three slots) in length to achieve a relatively short round trip delay for retransmissions between the UE and the Node B.

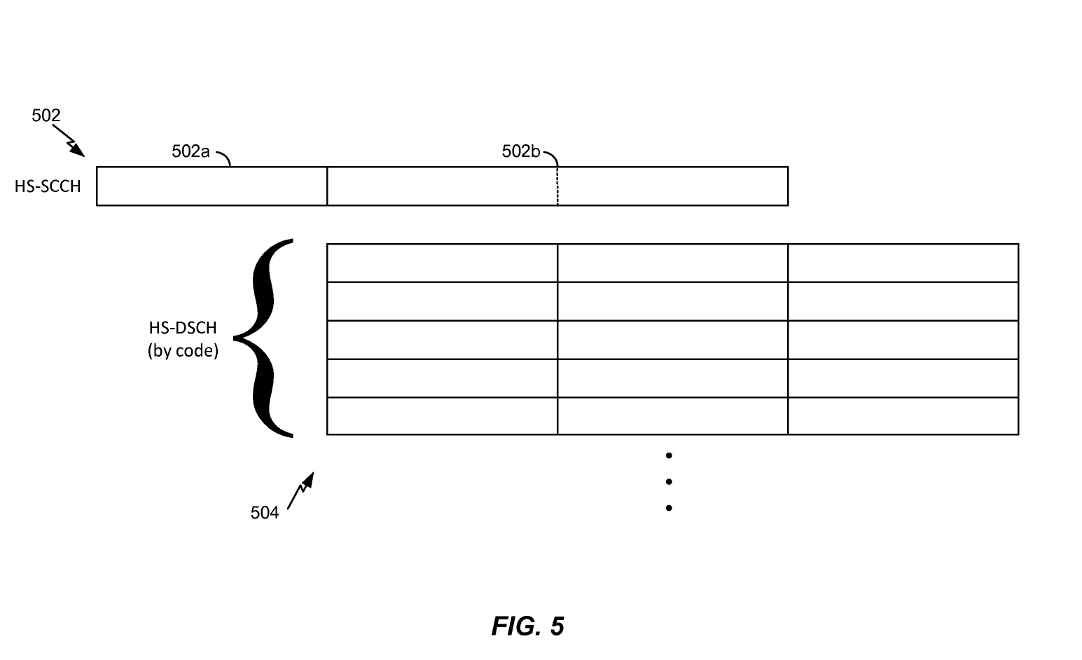

The HS-DSCH may be implemented by three physical channels: the high-speed physical downlink shared channel (HS-PDSCH), the high-speed shared control channel (HS-SCCH), and the high-speed dedicated physical control channel (HS-DPCCH). Among these physical channels, the HS-PDSCH may carry user data, and may be dynamically mapped to one or more code channels, as guided by the HS-SCCH. As illustrated in FIG. 5, the HS-SCCH 502 may be divided into two parts. In the first part 502a, which includes the first of three slots, the HS-SCCH 502 may include certain time-critical information to be utilized by the UE to receive the HS-DSCH 504, such as which codes to receive and which modulation and spreading factor is being used. The second part 502b, which includes two slots, may include additional information that is less time-critical for the UE. Thus, when a UE monitors the HS-SCCH 502 corresponding to a particular sector or cell, the UE may be enabled to receive and decode downlink data on the corresponding HS-DSCH 504, if there is data directed to that UE.

On the uplink, the HS-DPCCH may carry feedback signaling from the UE to assist the Node B in taking the right decision in terms of a modulation and coding scheme and a precoding weight selection. For example, this feedback signaling may include a CQI and a PCI. The HS-DPCCH may further include HARQ ACK/NACK signaling to indicate whether a corresponding packet transmission on a prior HS-DSCH was decoded successfully. That is, a UE may provide feedback to a Node B over the HS-DPCCH to indicate whether it correctly decoded a packet on the downlink.

One difference on the downlink between HSDPA and the previously standardized circuit-switched air-interface is the absence of soft handover in HSDPA. This means that data is transmitted to the UE from a single cell called the HSDPA serving cell. As the user moves, or as one cell becomes preferable to another, the HSDPA serving cell may change.

That is, in a conventional HSDPA system, at any instance a UE has one serving cell. According to mobility procedures defined in Release 5 of 3GPP TS 25.331, the Radio Resource Control (RRC) signaling messages for changing the HSPDA serving cell are transmitted from the current HSDPA serving cell (i.e., the source cell), and not the cell that the UE reports as being the stronger cell (i.e., the target cell). In a Serving Cell Change (SCC) procedure, the UE requests that the serving cell be changed from the currently serving source cell to a target cell. This request is sent to the UTRAN through a so-called “event 1D” message. The UTRAN and the UE exchange several messages and when the procedure is complete the HS data is served from the target cell.

Release 8 of the 3GPP standards brought dual cell HSDPA (DC-HSDPA), wherein a single UE may include dual receive chains, such that the UE may aggregate downlink information from two 5-MHz carrier frequencies. That is, in DC-HSDPA, a Node B may provide two HS-DSCH channels on two carrier frequencies to a UE in order essentially to double the downlink throughput. DC-HSDPA may provide the two HS-DSCH channels to a UE from a single sector, such that the scheduling of resources to that UE is consolidated into the single sector.

In still later releases of the 3GPP standards, 3C-HSDPA and 4C-HSDPA can provide further increases in user data rates beyond those of DC-HSDPA. Further development in still greater numbers of carriers is ongoing.

When a UE 434 (see FIG. 4) is using HSDPA service at the boundary of two neighboring sectors, the throughput of this service is often limited due to inter-sector interference or low signal quality from the serving sector. Due to interference from a neighboring sector and/or due to a weak signal from the serving sector the terminal might only get served with a very limited data rate. Thus, in a DC-HSDPA system, when the quality of one or both HS-DSCH channels degrades, the sector may simply hand over to another sector, which may then provide the dual cells to the UE.

Some of the benefits of utilizing DC-HSDPA UEs with an advanced receiver (e.g. Type 3i) in a single carrier 5 MHz deployment are known in the art. For example, some of the benefits are due to the fact that in addition to scheduling the UE from the serving HS-DSCH cell, if a neighbor cell is lightly loaded, the neighbor cell can also transmit to the DC-HSDPA UE an independent packet, thereby improving the user experience. The fact that such a UE utilizes an advanced receiver such as a linear interference suppressing equalizer (e.g., Type 3i) generally allows the UE to correctly decode both streams simultaneously.

In a realistic deployment, the system is infrequently fully utilized. For example, a UE's serving cell may experience a heavy load at a time when a neighboring cell (in the UE's active set) is comparatively more lightly loaded. If intra- or inter-NB aggregation were allowed, such a UE may be scheduled from both the serving cell and the neighboring cell, resulting in dynamic load-balancing in the network. If aggregation were not allowed, such a UE would only get scheduled from the serving cell and thereby may see relatively poorer performance.

Recently, DC-HSDPA UEs have been implemented in such a way that dual receive chains in the UE can be configured to receive the same 5-MHz carrier. This has been referred to as single-carrier, dual-cell HSDPA (SFDC-HSDPA), Coordinated Multi-Point HSDPA (CoMP-HSDPA), or simply Multi-Point HSDPA. In a Multi-Point HSDPA system, the receivers in the UE can provide receiver diversity such that the UE may receive downlink information from different cells provided by different Node Bs (inter-Node B aggregation), or from different cells provided by the same Node B (intra-Node B aggregation). Typically, one of the cells is referred to as the primary serving cell, while the other cell or cells are referred to as secondary serving cells.

Multi-point HSDPA has generated significant interest due to its potential to improve performance for UEs in soft and softer handover, and to reduce inter-cell interference at or near the border between cells. However, to reduce expense and complexity, many UEs do not implement plural receivers and include only a single receive antenna for HSDPA usage. In these UEs, aggregation of plural simultaneously-transmitted downlink carriers is generally not possible.

In such a UE having a single receive antenna, and particularly if the UE does not include an advanced receiver such as the type 3i receiver, the gains achieved with DC-HSDPA or Multi-Point HSDPA may not be available. That is, UEs with a single receive antenna are generally unable to suppress inter-cell interference as effectively as UEs with receiver diversity. Nonetheless, there is a desire to provide a diversity benefit to such UEs in single-path fading scenarios.

Thus, in an aspect of the present disclosure, a UE with a single receive antenna may attain some of the benefits of receive diversity by utilizing switching based aggregation, wherein a UE in soft or softer handover is served by the strongest of the primary and secondary serving cells during a particular interval. For example, rather than sending simultaneous downlinks to a UE from a primary serving cell and a secondary serving cell, a packet may be transmitted from the stronger of the cells during a particular interval to a UE having a single receive chain, with the stronger cell being determined in accordance with feedback information from the UE. This feedback information may include the CQI or any other suitable indicator of channel quality or strength of the respective downlink channels. This may be considered the same or similar to dynamically switching the serving cell of the UE at given intervals, based on the CQI feedback.

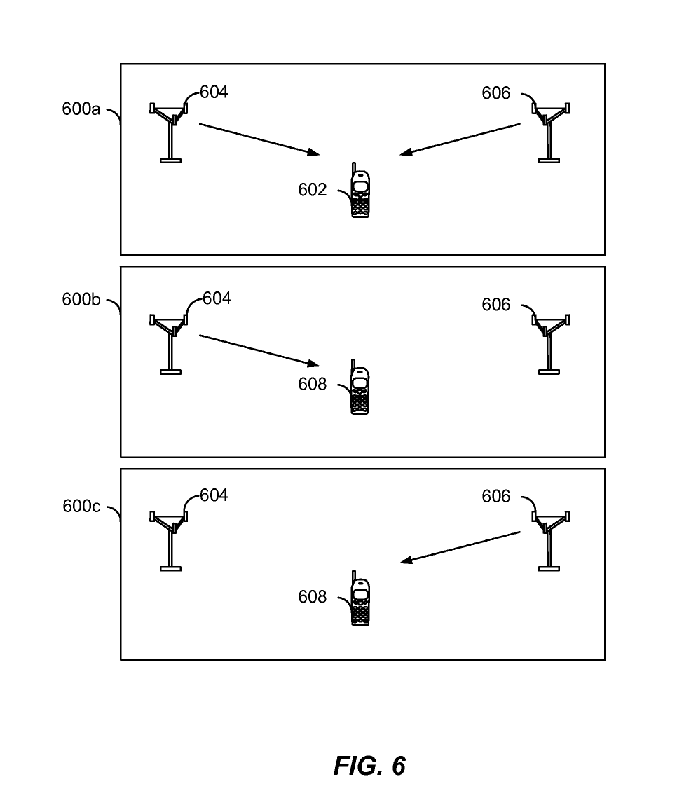

For example, FIG. 6 is a simplified diagram illustrating a switching-based aggregation system in accordance with some aspects of the disclosure. In illustration 600a, a UE 602 configured for multi-point HSDPA can receive a downlink from two cells 604 and 606 simultaneously. However, a UE such as UE 608 that includes a single receive antenna may not be capable of receiving the dual downlinks at the same time. Thus, the UE 608 may receive a downlink transmission from the first cell 604 during a first interval as illustrated in illustration 600b, and the UE 608 may receive a downlink transmission from the second cell 606 during a second interval as illustrated in illustration 600c. Here, the scenario in illustration 600b and 600c may switch from interval to interval in accordance with feedback from the UE 608.

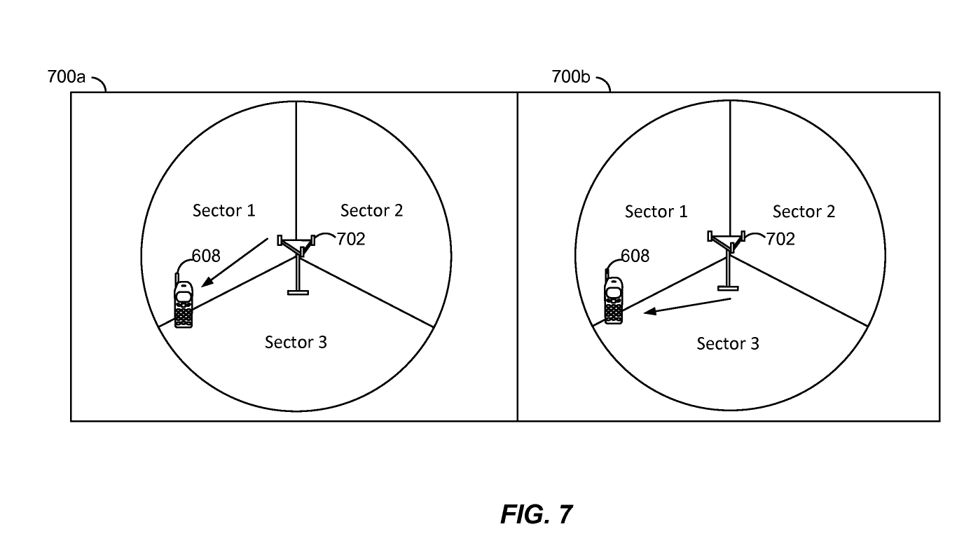

FIG. 7 illustrates intervals 700a and 700b, showing that the UE 608 may be capable of switching between two cells provided by the same Node B 702, in addition to switching between two cells provided by different Node Bs 604 and 606 as illustrated in FIG. 6.

In a further aspect of the present disclosure, a UE with dual receive chains in a network utilizing dual frequencies may utilize a similar switching scheme as described above at each of the receive chains, thus achieving some of the benefits of a 4-carrier system. That is, switching-based aggregation of two or more carriers based on feedback from the UE may be implemented at each of a plurality receive chains. This may be considered substantially equivalent to operating the switching scheme described above on two frequencies independently. In this aspect of the present disclosure, the UE may utilize a single receive antenna, since at most one packet is transmitted to the UE on any frequency. Of course, any suitable number of antennas may be utilized in various examples.

Here, the UE may include two cells in its Active Set and may be configured to receive two packets at the same time: one on each frequency, and from one of the two cells in that frequency. Thus, during a given interval one cell transmits to the UE per frequency.

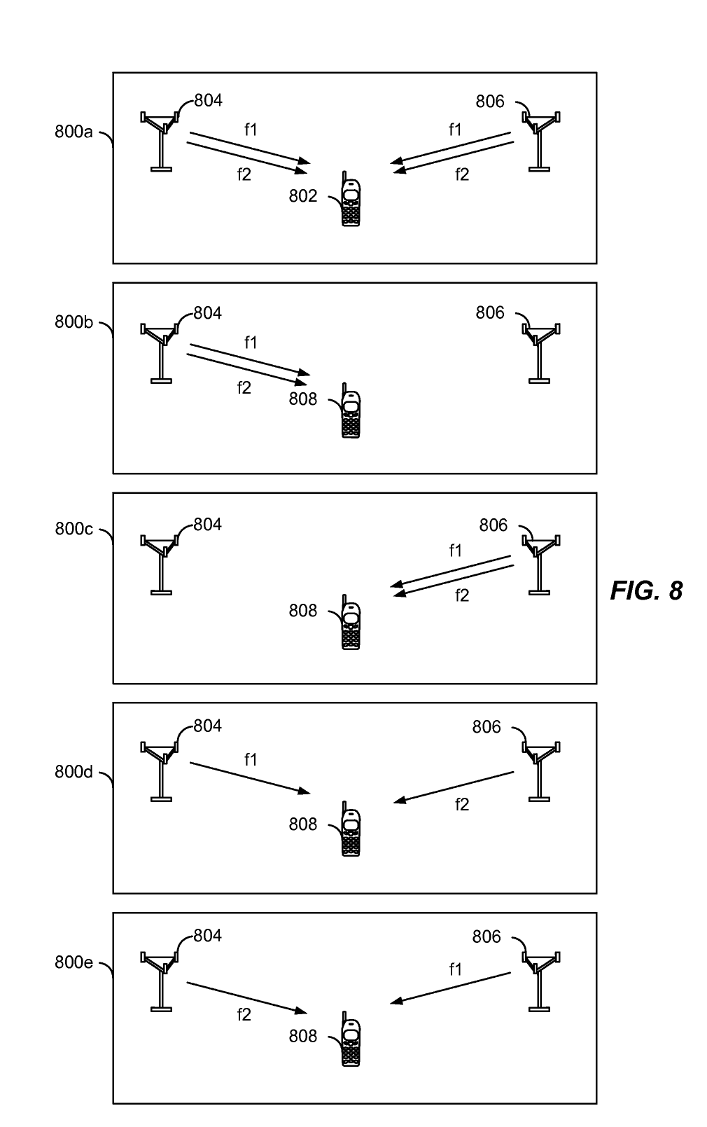

For example, FIG. 8 is a simplified diagram illustrating a switching-based aggregation in accordance with some aspects of the disclosure. In illustration 800a, a UE 802 configured for dual-frequency dual-cell HSDPA can receive dual-carrier downlinks from each of two cells 804 and 806 simultaneously. However, a UE such as UE 808 that includes dual receive chains may not be capable of receiving all four downlinks at the same time. Thus, the UE 808 may receive dual downlink transmissions from the first cell 804 during a first interval as illustrated in illustration 800b; the UE 808 may receive dual downlink transmissions from the second cell 806 during a second interval as illustrated in illustration 800c; the UE 808 may receive a single downlink transmission at a first frequency from the first cell 804 and a single downlink transmission at a second frequency from the second cell 806 during a third interval as illustrated in illustration 800d; and the UE 808 may receive a single downlink transmission at the first frequency from the second cell 806 and a single downlink transmission at the second frequency from the first cell 804 during a fourth interval as illustrated in illustration 800e. Here, the scenario in illustrations 800b-800d may switch from interval to interval in accordance with feedback from the UE 808. That is, the UE 808 may provide feedback for each of the two cells on each of the two frequencies per interval.

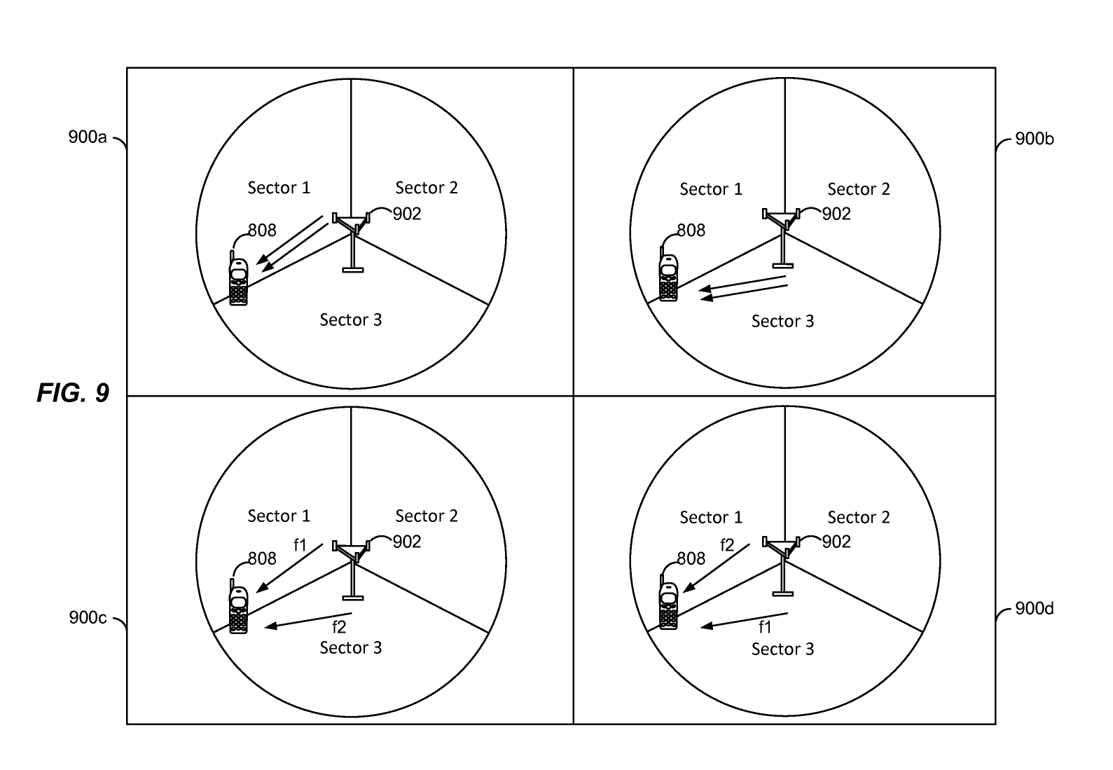

FIG. 9 illustrates intervals 900a-900d, showing that the UE 808 may be capable of switching between two cells provided by the same Node B 902, in addition to switching between two cells provided by different Node Bs 804 and 806 as illustrated in FIG. 8. Here, the UE 808 may receive both frequencies from a single sector as illustrated in 900a and 900b, or the UE may receive a single frequency from each sector as illustrated in 900c and 900d.

Of course, in still further aspects of the disclosure, any number of receive chains may implement switching-based aggregation in accordance with the features described below.

Some implementations according to the present disclosure may provide significant improvement in burst rate during a soft or softer handover, as well as improved HS-DSCH coverage in single 5 MHz carrier deployments for UEs that are limited to a single receive antenna and lack a Type 3i receiver.

In much of the detailed description of exemplary aspects of the present disclosure hereinbelow, an HSDPA system is utilized as an illustrative example; however, other systems and networks may be utilized in accordance with the various aspects of this disclosure. For example, feedback from the UE may be implemented as CQI information on an HS-DPCCH, or as any suitable feedback information on any uplink channel.

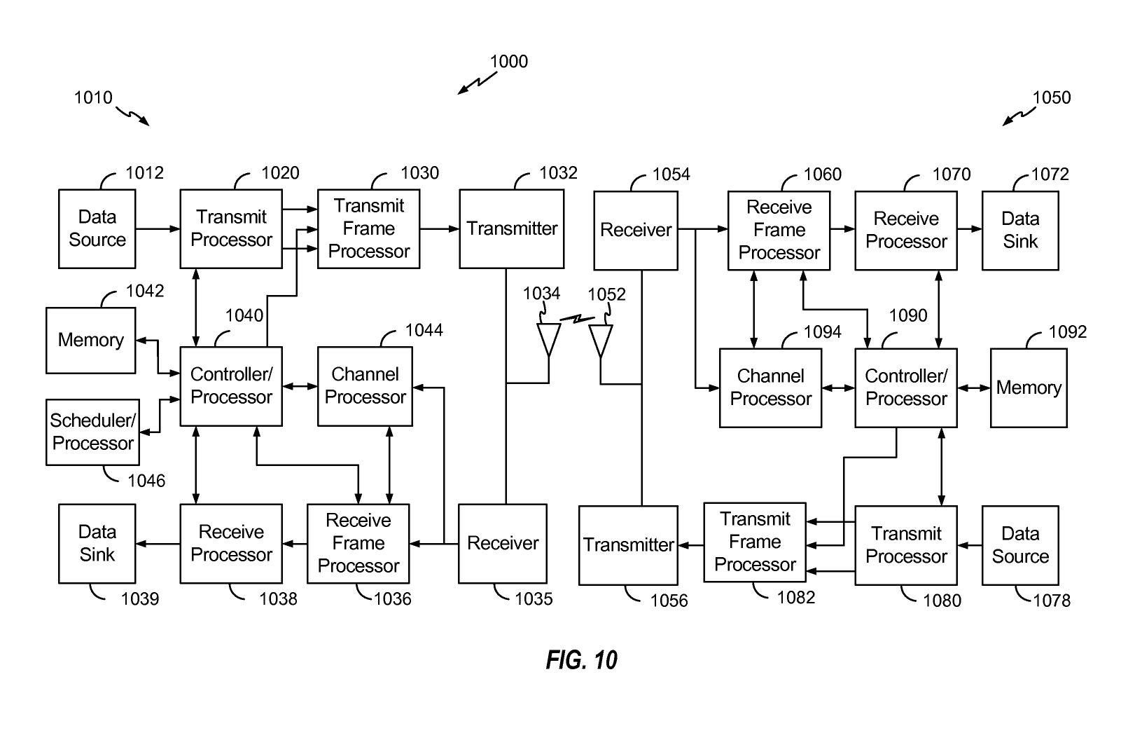

FIG. 10 is a block diagram of an exemplary Node B 1010 in communication with an exemplary UE 1050, where the Node B 1010 may be the Node B 308 in FIG. 3, and the UE 1050 may be the UE 310 in FIG. 3. In downlink communication, a transmit processor 1020 at the Node B 1010 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050, such as a CQI. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

In some examples in accordance with the present disclosure, as described with reference to the various sector transmitting antennas 418, 420, and 422 of a Node B 444 as illustrated in FIG. 4, some of the portions of the Node B 1010 may be duplicated in order to implement a plurality of sectors at a Node B. For example, a Node B 1010 providing two sectors may include two transmitters 1032, two receivers 1035, and/or two antennas 1034. Other portions of the Node B 1010 may additionally be duplicated, or in other examples the illustrated processors and other blocks may be configured to support dual transmitters 1030, receivers 1035, and/or antennas 1034.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1094 and the data, control, and reference signals to a receive processor 1070. The receive processor 1070 then performs the inverse of the processing performed by the transmit processor 1020 in the Node B 1010. More specifically, the receive processor 1070 descrambles and despreads the symbols, and then determines the most likely signal constellation points transmitted by the Node B 1010 based on the modulation scheme. These soft decisions may be based on channel estimates computed by the channel processor 1094. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1090. When frames are unsuccessfully decoded by the receiver processor 1070, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided to a transmit processor 1080. The data source 1078 may represent applications running in the UE 1050 and various user interfaces (e.g., keyboard). Similar to the functionality described in connection with the downlink transmission by the Node B 1010, the transmit processor 1080 provides various signal processing functions including CRC codes, coding and interleaving to facilitate FEC, mapping to signal constellations, spreading with OVSFs, and scrambling to produce a series of symbols. Channel estimates, derived by the channel processor 1094 from a reference signal transmitted by the Node B 1010 or from feedback contained in the midamble transmitted by the Node B 1010, may be used to select the appropriate coding, modulation, spreading, and/or scrambling schemes. The symbols produced by the transmit processor 1080 will be provided to a transmit frame processor 1082 to create a frame structure. The transmit frame processor 1082 creates this frame structure by multiplexing the symbols with information from the controller/processor 1090, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the Node B 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1080 in the UE 1050. The data and control signals carried by the successfully decoded frames may then be provided to a data sink 1039 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the Node B 1010 and the UE 1050, respectively. For example, the controller/processors 1040 and 1090 may provide various functions including timing, peripheral interfaces, voltage regulation, power management, and other control functions. The computer readable media of memories 1042 and 1092 may store data and software for the Node B 1010 and the UE 1050, respectively. A scheduler/processor 1046 at the Node B 1010 may be used to allocate resources to the UEs and schedule downlink and/or uplink transmissions for the UEs.

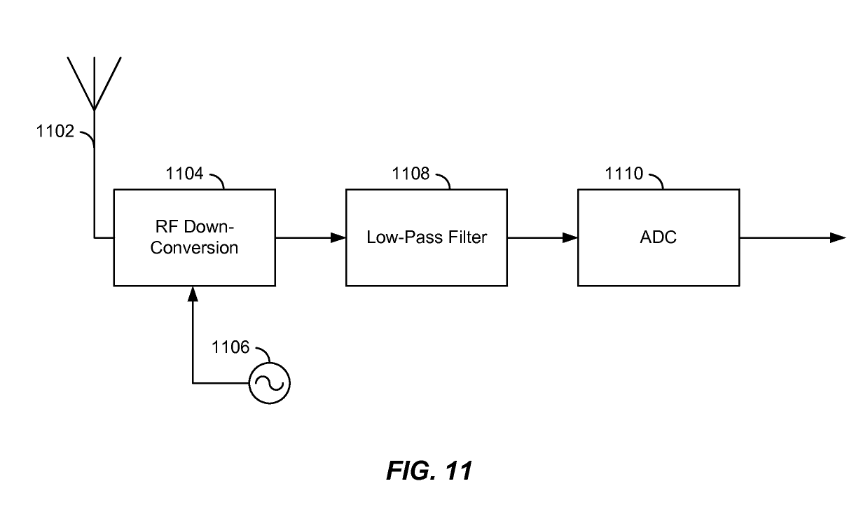

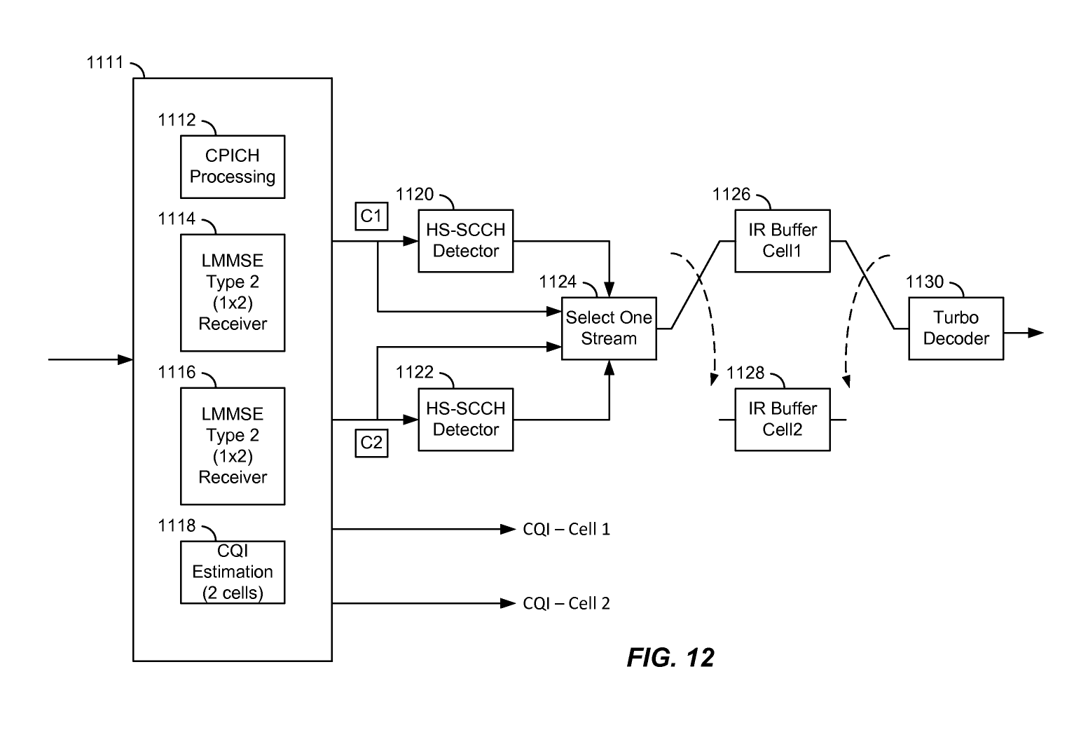

Aspects of the present disclosure may be implemented by a UE 1050 having a receiver 1054 that possesses a single baseband receive chain, but is capable of monitoring HS-SCCH on both cells. FIGS. 11 and 12 are block diagrams illustrating one example of an RF/Front end and baseband processing portions of such a UE 1050. Of course, any suitable RF/Front end and baseband processor may be utilized in a UE 1050 in accordance with various aspects of the present disclosure.

FIG. 11 is a simplified block diagram illustrating the RF front end for a UE that includes a single receive chain for implementing Multi-Point HSDPA in accordance with some aspects of the present disclosure. In some aspects of the disclosure, the RF front end illustrated in FIG. 11 may correspond to the receiver 1054 of the UE 1050 illustrated in FIG. 10. Those skilled in the art will recognize that the illustrated RF front end is substantially the same as the RF front end for a conventional HSDPA-enabled UE. Those skilled in the art will further recognize that at least a portion of the RF front end illustrated in FIG. 11 may be duplicated in a particular UE that includes dual receive chains for implementing switching-based aggregation in a dual carrier network, e.g., in a DF-4C system, as described in further detail below. In the illustrated example, a receive antenna 1102 provides a received signal to an RF down-conversion block 1104 for down-converting the received signal to baseband in accordance with an oscillator 1106 operating at the appropriate carrier frequency. The baseband signal is then provided to a low-pass filter 1108 for removing high-frequency components, and then to an analog-to-digital converter (ADC) 1110 for generating a digital signal.

FIG. 12 is a simplified block diagram illustrating some aspects of a baseband processor for a UE that includes a single receive antenna for implementing Multi-Point HSDPA in accordance with some aspects of the present disclosure. In the illustrated example, an input signal is provided by an RF front end, such as the RF front end illustrated in FIG. 11. The baseband processor may include a channel processor 1111. In some aspects of the disclosure, the channel processor 1111 may correspond to the channel processor 1094 of the UE 1050 illustrated in FIG. 10. In some aspects of the disclosure, the channel processor 1111 may include a CPICH processing block 1112, a first linear minimum mean square error (LMMSE) type 2 receiver, a second LMMSE type 2 receiver, and a CQI estimation block 1118. Here, the CQI estimation block 1118 may perform channel estimation in accordance with information from the CPICH processing block 1112 and the LMMSE receivers 1114 and 1116 for each of the cells, and may accordingly generate CQI outputs for each of the cells. The process for channel estimation and generation of the CQIs is known to those skilled in the art and is therefore not described in detail in the present disclosure.

The baseband processor may further include a first HS-SCCH detector 1120 and a second HS-SCCH detector 1122. Here, information from cell 1 (C1) such as the HS-DSCH may be provided to the first HS-SCCH detector, for monitoring the HS-SCCH and preparing the baseband processor to decode the data channel (e.g., the HS-PDSCH) from the first cell. Similarly, information from cell 2 (C2) such as its HS-DSCH may be provided to the second HS-SCCH detector, for monitoring the HS-SCCH and preparing the baseband processor to decode the data channel (e.g., the HS-PDSCH) from the second cell. The corresponding HS-DSCHs may additionally be provided to a stream selection block 1124 for determining which of the cells has scheduled data for the UE in a particular interval, and forwarding the corresponding data carried on the HS-PDSCH and decoding information from the corresponding HS-SCCH to a corresponding one of a first incremental redundancy (IR) buffer 1126 or a second IR buffer 1128, Here, the IR buffers are configured for buffering HARQ information utilized for generating HARQ retransmissions for the corresponding stream. The information may then be provided to a turbo decoder 1130 for decoding the corresponding stream and forwarded on to other processing blocks in accordance with the details of a particular implementation. In some examples, as illustrated in FIG. 10, the output of the turbo decoder 1130 may be provided to a data sink 1039 for utilization by any suitable application.

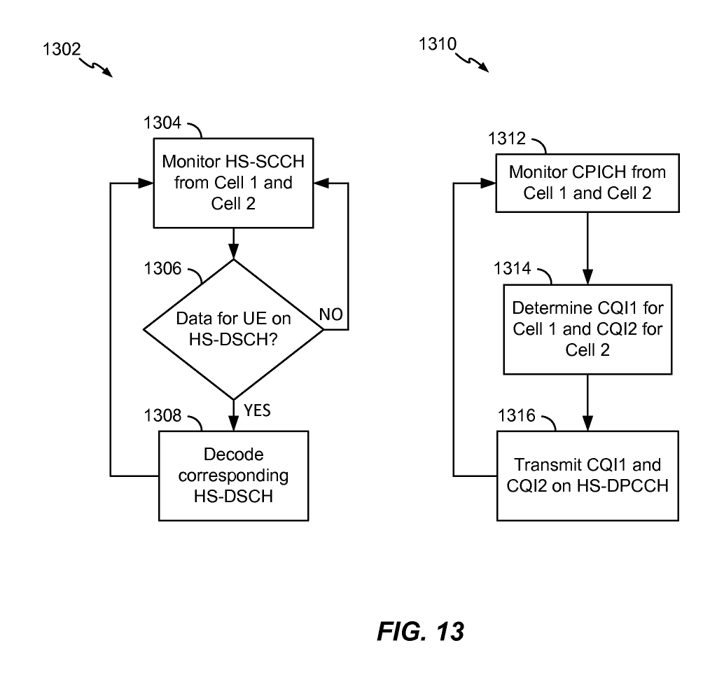

FIG. 13 is a flow chart illustrating two portions of an exemplary process for wireless communication in accordance with some aspects of the present disclosure. In some examples, the two illustrated portions may be independent processes, which may be executed concurrently. In some examples, the two illustrated portions maybe executed sequentially as a part of a combined process. Here, the processes illustrated in FIG. 13 may be executed at a UE, e.g., the UE 310 illustrated in FIG. 3.

In flow diagram 1302, at block 1304 the process may monitor a first control channel (e.g., an HS-SCCH) from a first cell and a second control channel (e.g., a second HS-SCCH) from a second cell. In some aspects of the disclosure, the receiver 1054 (see FIG. 10) may be utilized to monitor the control channels, and in some further aspects of the disclosure, the HS-SCCH detectors 1120 and 1122 (see FIG. 12) may be utilized to monitor the respective control channels. Here, the first and second control channels may be continuously monitored or may be monitored at suitable intervals, and the first and second control channels may be monitored concurrently or at different times. Furthermore, due to the nature of the Multi-Point HSDPA system utilized in accordance with various aspects of the present disclosure, the first and second control channels may be on the same carrier frequency, and further, may be separated in accordance with the utilization of suitable scrambling codes.

In block 1306 the process may determine whether downlink data directed for the UE is provided on one of the HS-DSCHs corresponding to the first or second cell. Here, the determination may be made by the selection block 1124 (see FIG. 12) by monitoring the HS-DSCHs from the corresponding cells and utilizing the information from the corresponding HS-SCCH to find data directed for the UE on the corresponding HS-PDSCH. If there is no data for the UE on either HS-DSCH, the process may return to block 1304 to monitor the HS-SCCHs. If, however, there is data for the UE on one of the HS-DSCHs, then the process may proceed to block 1306.

In block 1306, the process may decode the downlink data on the corresponding one of the first or second downlink data channels (e.g., the HS-PDSCHs). Here, the decoding of the downlink data may include utilizing the control information obtained from the corresponding one of the first or second control channel. In some aspects of the disclosure, decoding the downlink data may be accomplished in accordance with the incremental redundancy buffer 1126 and turbo decoder 1130 (see FIG. 12). In some aspects of the disclosure, decoding the downlink data may be accomplished in accordance with the receive frame processor 1060 and receive processor 1070 (see FIG. 10) as described above.

In some aspects of the present disclosure, the process illustrated at flow diagram 1302 may be implemented at periodic or intermittent intervals. In some examples, the interval over which the process repeats may be one TTI. In particular, repetition of the process 1302 each TTI may be utilized when the first and second cells are sectors provided by the same Node B, in which case scheduling of data for the UE may be more rapid (e.g., each TTI) than the case if the cells are provided by disparate Node Bs. However, in examples where the cells are sectors provided by the same Node B and in examples where the cells are provided by disparate Node Bs, the interval over which the process 1302 is repeated may be any suitable time interval from one TTI or longer, and may be periodic or aperiodic in accordance with the particular design choices in a particular system.

In flow diagram 1310, at block 1312 the process may monitor first and second reference signals (e.g., a common pilot channel CPICH) from the first and second cells, and at block 1314 the process may measure the CPICHs, determine a characteristic (e.g., a channel quality) of the first and second cells, and may generate corresponding channel quality indicators (CQI) for the first and second cells. In some aspects of the present disclosure, the monitoring of the reference signals and the determination of the characteristic(s) of the cells may be accomplished by the CPICH processing block 1112 in combination with the CQI estimation block 1118 (see FIG. 12) as described above. In some aspects of the disclosure, the monitoring of the reference signals and the determination of the characteristic(s) of the cells may be accomplished by the receiver 1054 in combination with the channel processor 1094 (see FIG. 10) as described above.

The periodicity of CQI reporting illustrated in flow diagram 1310 is generally configurable by the UTRAN, and may range anywhere from 2 ms (i.e., one CQI report every TTI) to 160 ms, although aspects of the present disclosure may be implemented with any suitable interval for CQI reporting.

In some aspects of the present disclosure, the CQI reporting on the HS-DPCCH for the plural cells being monitored by the UE may be reported utilizing a conventional Rel-8 HS-DPCCH structure including HARQ ACK/NACK and CQI information. That is, Rel-8 of the 3GPP standards for DC-HSDPA included a definition of the HS-DPCCH wherein a UE reported a HARQ ACK/NACK and CQI for each of two downlink carriers. In some aspects of the present disclosure, the same HS-DPCCH structure can be utilized to report the CQI for each of the first cell and the second cell.

However, in some aspects of the present disclosure utilizing switching-based Multi-Point HSDPA, the HS-DSCH from only a single cell is received in a given interval (e.g., in a TTI), unlike a DC-HSDPA system wherein dual HS-DSCHs may be simultaneously received. Thus, in some aspects of the present disclosure, the single HARQ ACK/NACK is reported utilizing the Rel-8 HS-DPCCH structure, while one of the ACK/NACK codewords may be set to DTX (discontinuous transmission) for the non-received cell.

In another aspect of the present disclosure, when at least one CQI corresponds to the first characteristic and the second characteristic, it may be that a single CQI jointly encodes feedback corresponding to both channels. Alternatively, a first CQI may correspond to a first channel, while a second CQI may correspond to a second channel.

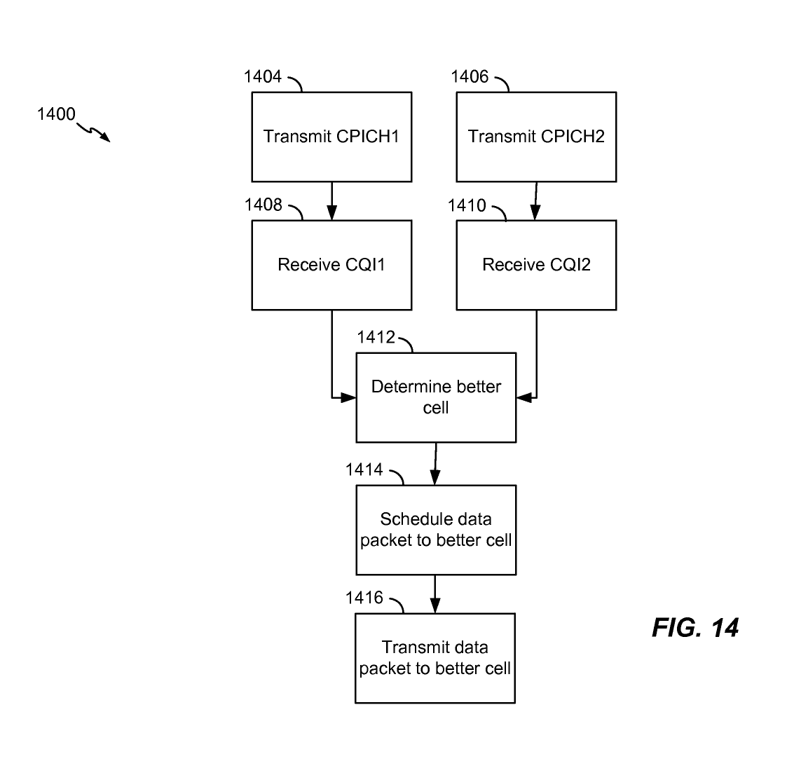

FIG. 14 is a flow chart illustrating an exemplary process 1400 for wireless communication in accordance with some aspects of the present disclosure. In some aspects, the process may be implemented by a Node B transmitting dual cells over the same frequency channel as dual sectors. In some aspects, the process may be implemented jointly by dual Node Bs, each transmitting a respective cell, wherein both of the cells from the dual Node Bs are transmitted over the same frequency channel. In some aspects, portions of the process may be implemented by another node in a network such as the RNC 306 (see FIG. 3).

In the exemplary process 1400, at block 1404 the process may transmit a first pilot signal (e.g., a first CPICH) for the first cell, and at block 1406 the process may transmit a second pilot signal (e.g., a second CPICH) for the second cell, wherein the first pilot signal and the second signal may be in the same carrier frequency. In an HSDPA system, the CPICH is generally a fixed rate downlink physical channel that carries a pre-defined bit sequence, and can be utilized by UEs to determine the primary scrambling code for that cell as well as for phase and power estimations and generation of a channel quality estimate. In some aspects of the disclosure, the transmission of a respective pilot signal may be implemented by the transmitter 1032 of the Node B 1010 (see FIG. 10). In examples where the cells are different sectors provided by the same Node B, the transmission of the first pilot signal may be implemented by a first transmitter 1032 of the Node B 1010, and the transmission of the second pilot signal may be implemented by a second transmitter 1032 of the Node B 1010. Of course, other examples are possible within the scope of the present disclosure, such as one where a transmitter 1032 is capable of providing both the first pilot signal and the second pilot signal.

In block 1408 the process may receive a first CQI corresponding to a characteristic (e.g., a channel quality) of the first pilot signal, and in block 1410 the process may receive a second CQI corresponding to a characteristic (e.g., a channel quality) of the second pilot signal. In some aspects of the disclosure, the reception of a respective CQI may be implemented by the receiver 1035 of the Node B 1010 (see FIG. 10). In examples where the cells are different sectors provided by the same Node B, the reception of the first CQI may be implemented by a first receiver 1035 of the Node B 1010, and the reception of the second CQI may be implemented by a second receiver 1035 of the Node B 1010. Of course, other examples are possible within the scope of the present disclosure, such as one where a receiver 1035 is capable of receiving both the first CQI and the second CQI. Further, in another aspect of the disclosure, rather than receiving two separate CQls as illustrated, within the scope of the present disclosure a process may receive a combined CQI configured to encode the respective characteristics of both the first and second cells from the UE.

In block 1412, the process may determine a better cell among the first cell and the second cell. Here, the determination of the better cell may be based at least in part on at least one of the first CQI and the second CQI. In some aspects of the disclosure, the determination of the better cell may utilize the most recently received CQls corresponding to the respective CPICHs, or may utilize any number of previously received CQls.

In some aspects of the disclosure, both cells may be sectors provided by the same Node B. In this example, the Node B may have the CQI or other feedback information corresponding to both cells readily available, such that the Node B may rapidly determine the better cell among the first cell and the second cell. Thus, dynamic switching between cells may be made with relatively little lag time, e.g., at each TTI. Of course, the determination of the better cell in block 1412 may occur at any suitable interval, e.g., in accordance with the frequency that the CQIs or received or some other interval, and may occur every TTI or at some other interval. Further, the determination of the better cell may be based on any suitable factors or parameters, including loading conditions or a queue length at each cell. That is, a determination to transmit downlink data to the UE over one cell may be based in part on information that the other cell is relatively heavily loaded. In some aspects of the disclosure, the determination of the better cell may be implemented by the channel processor 1044 of the Node B 1010 (see FIG. 10). In some aspects of the disclosure, the determination of the better cell may be implemented by the controller/processor 1040, possibly in conjunction with the channel processor 1044. In some aspects of the disclosure, the determination of the better cell may utilize information from the scheduler/processor 1046 relating to the loading conditions at the cell.

Some examples in accordance with the present disclosure may provide the plural downlink cells from disparate base stations. In this instance, some form of information sharing may be utilized between the base stations, e.g., an X1 interface between eNode Bs in an LTE network, or an lub interface coupling the disparate Node Bs to an RNC. In any case, at least one of the base stations or another network node such as an RNC may be utilized to make the determination of the better cell among the first and second cell for scheduling the downlink data. Thus, in accordance with the present disclosure the determination of the better cell in block 1412 may be made at another node in the network such as the RNC 306 (see FIG. 3). For example, the Node B may send a request over an lub interface to the RNC for data based on, e.g., the received CQI, a queue length, or any other suitable information, and the RNC 306 may thereby make the determination of the better cell in accordance with this information as well as information from another Node B.

In block 1414, the process may schedule a packet of data for the UE on the better cell determined in block 1412. In some aspects of the disclosure, the scheduling of the packet may be implemented by the scheduler/processor 1046 of the Node B 1010 (see FIG. 10), as described above. In block 1416, the process may transmit the scheduled packet to the UE over the better cell, as determined in block 1412 and scheduled in block 1414. In some aspects of the disclosure, the transmitting of the packet may be implemented by the transmitter 1032 of the Node B 1010. In examples where the cells are different sectors provided by the same Node B, the transmission of the scheduled packet may be implemented by a corresponding one of a first transmitter 1032 or a second transmitter 1032 of the Node B 1010. Of course, other examples are possible within the scope of the present disclosure, such as one where a transmitter 1032 is capable of transmitting the scheduled packet over either one of the first cell or the second cell.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
monitoring a first control channel from a first cell and a second control channel from a second cell, wherein the first cell provides a first downlink data channel in a first carrier frequency and the second cell provides a second downlink data channel in the first carrier frequency; and
decoding first downlink data on only one of the first downlink data channel or the second downlink data channel during a first time interval.

2. The method of claim 1, further comprising:
transmitting feedback corresponding to a first characteristic of the first cell and a second characteristic of the second cell,
wherein the first downlink data is adapted in accordance with the feedback.

3. The method of claim 2, further comprising determining the first characteristic of the first cell and the second characteristic of the second cell,
wherein the feedback comprises at least one channel quality indicator corresponding to the first characteristic and the second characteristic.

4. The method of claim 2, wherein the first downlink data is scheduled to be sent during the first time interval over one of the first downlink data channel or the second downlink data channel in accordance with the feedback.

5. The method of claim 1, wherein the first time interval comprises a TTI.

6. The method of claim 1, wherein the decoding of the first downlink data comprises decoding the first downlink data channel or the second downlink data channel in accordance with a corresponding one of the first control channel or the second control channel.

7. The method of claim 1, further comprising:
monitoring a third control channel from a third cell and a fourth control channel from a fourth cell, wherein the third cell provides a third downlink data channel in a second carrier frequency different from the first carrier frequency and the fourth cell provides a fourth downlink data channel in the second carrier frequency; and
decoding second downlink data on only one of the third downlink data channel or the fourth downlink data channel during the first time interval.

8. The method of claim 7, further comprising:
transmitting feedback corresponding to a third characteristic of the third cell and a fourth characteristic of the fourth cell,
wherein the second downlink data is adapted in accordance with the feedback.

9. The method of claim 7, wherein the second downlink data is scheduled to be sent during the first time interval over one of the third downlink data channel or the fourth downlink data channel in accordance with the feedback.

10. A method of wireless communication, comprising:
transmitting a first pilot signal for a first cell;
transmitting a second pilot signal for a second cell;
receiving from a UE at least one channel quality indicator corresponding to a characteristic of the first pilot signal and second pilot signal;
determining, based at least in part on the at least one channel quality indicator, a better cell among the first cell and the second cell; and
scheduling a packet for the UE on the better cell.

11. The method of claim 10, further comprising: transmitting the packet to the UE utilizing the better cell.

12. The method of claim 10, wherein the determining of the better cell is performed on a per-TTI basis.

13. The method of claim 10, wherein the determining of the better cell is based further on loading conditions at each of the first cell and the second cell.

14. The method of claim 10, further comprising:
transmitting a third pilot signal for a third cell;
transmitting a fourth pilot signal for a fourth cell;
receiving from the UE at least one second channel quality indicator corresponding to a characteristic of the third pilot signal and fourth pilot signal;
determining, based at least in part on the at least one second channel quality indicator, a second better cell among the third cell and the fourth cell; and
scheduling a second packet for the UE on the second better cell.

15. The method of claim 14, further comprising: transmitting the second packet to the UE utilizing the second better cell.

16. An apparatus for wireless communication, comprising:
a receiver for receiving a first reference signal from a first cell and a second reference signal from a second cell, wherein the first cell and the second cell are in the same carrier frequency;
a channel processor for determining a first channel estimate corresponding to the first reference signal and a second channel estimate corresponding to the second reference signal;
a transmitter for transmitting a first channel quality indication corresponding to the first channel estimate and a second channel quality indication corresponding to the second channel estimate;
a receive processor for receiving first control information from the first cell and second control information from the second cell, and for providing decoding control information for decoding a data channel; and
a controller (1090) for decoding only one of a first data channel or a second data channel in accordance with the decoding control information for a corresponding one of the first cell or the second cell during a first time interval.

17. An apparatus for wireless communication, comprising:
means for monitoring a first control channel from a first cell and a second control channel from a second cell, wherein the first cell provides a first downlink data channel in a first carrier frequency and the second cell provides a second downlink data channel in the first carrier frequency; and
means for decoding downlink data on only one of the first downlink data channel or the second downlink data channel during a first time interval.

18. The apparatus of claim 17, further comprising:
means for transmitting feedback corresponding to a first characteristic of the first cell and a second characteristic of the second cell,
wherein the downlink data is adapted in accordance with the feedback.

19. The apparatus of claim 18, further comprising means for determining the first characteristic of the first cell and the second characteristic of the second cell,
wherein the feedback comprises at least one channel quality indicator corresponding to the first characteristic and the second characteristic.

20. The apparatus of claim 18, wherein the downlink data is scheduled to be sent during the first time interval over one of the first downlink data channel or the second downlink data channel in accordance with the feedback.

21. The apparatus of claim 17, wherein the first time interval comprises a TTI.

22. The apparatus of claim 17, wherein the means for decoding the downlink data comprises means for decoding the first downlink data channel or the second downlink data channel in accordance with a corresponding one of the first control channel or the second control channel.

23. The apparatus of claim 17, further comprising:
means for monitoring a third control channel from a third cell and a fourth control channel from a fourth cell, wherein the third cell provides a third downlink data channel in a second carrier frequency different from the first carrier frequency and the fourth cell provides a fourth downlink data channel in the second carrier frequency; and
means for decoding second downlink data on only one of the third downlink data channel or the fourth downlink data channel during the first time interval.

24. The apparatus of claim 23, further comprising:
means for transmitting feedback corresponding to a third characteristic of the third cell and a fourth characteristic of the fourth cell,
wherein the second downlink data is adapted in accordance with the feedback.

25. The apparatus of claim 23, wherein the second downlink data is scheduled to be sent during the first time interval over one of the third downlink data channel or the fourth downlink data channel in accordance with the feedback.

26. An apparatus for wireless communication, comprising:
means for transmitting a first pilot signal for a first cell;
means for transmitting a second pilot signal for a second cell;
means for receiving from a UE at least one channel quality indicator corresponding to a characteristic of the first pilot signal and second pilot signal;
means for determining, based at least in part on the at least one channel quality indicator, a better cell among the first cell and the second cell; and
means for scheduling a packet for the UE on the better cell.

27. The apparatus of claim 26, further comprising: means for transmitting the packet to the UE utilizing the better cell.

28. The apparatus of claim 26, wherein the means for determining the better cell is configured to determine the better cell on a per-TTI basis.

29. The apparatus of claim 26, wherein the means for determining the better cell is configured to determine the better cell based further on loading conditions at each of the first cell and the second cell.

30. The apparatus of claim 26, further comprising:
means for transmitting a third pilot signal for a third cell;
means for transmitting a fourth pilot signal for a fourth cell;
means for receiving from the UE at least one second channel quality indicator corresponding to a characteristic of the third pilot signal and fourth pilot signal;
means for determining, based at least in part on the at least one second channel quality indicator, a second better cell among the third cell and the fourth cell; and
means for scheduling a second packet for the UE on the second better cell.

31. The apparatus of claim 30, further comprising: means for transmitting the second packet to the UE utilizing the second better cell.
